(19) United States
(12) Patent Application Publication
(10) Pub. No.: US 2015/0288249 A1
(43) Pub. Date: Oct. 8, 2015

(54) ECCENTRIC MOTOR

(71) Applicant: Schaeffler Technologies AG & Co. KG, Herzogenaurach (DE)

(72) Inventors: Jeffrey Hemphill, Copley, OH (US); Robby Lipfert, Ilmenau (DE); Wolfgang Reik, Buehl (DE)

(73) Assignee: SCHAEFFLER TECHNOLOGIES AG & CO. KG, Herzogenaurach (DE)

(21) Appl. No.: 14/665,725

(22) Filed: Mar. 23, 2015

Related U.S. Application Data
(60) Provisional application No. 61/974,835, filed on Apr. 3, 2014.

(51) Int. Cl. H02K 7/116

(52) U.S. Cl. CPC H02K 7/116

(57) ABSTRACT

An electric propulsion device includes a first stator with at least one first wire coil and a first centerline and a first rotor installed on an eccentric shaft such that the first rotor rolls in to and out of contact with portions of the first stator. In an example embodiment, the electric propulsion device has a housing and a bearing. The stator is installed in the housing and the bearing positions the eccentric shaft about the first centerline. In an example embodiment, the at least one first wire coil is a plurality of wire coils that are energized fully or partially to rotate the first rotor in the first stator.

### FIELD

The invention relates generally to an electric motor, and more specifically to an eccentric motor.

### BACKGROUND

An electric motor with an eccentric axle is known. One example is shown in U.S. Pat. No. 5,030,866 to Kawai, hereby incorporated by reference as if set forth fully herein.

### BRIEF SUMMARY

Example aspects broadly comprise an electric propulsion device including a first stator with at least one first wire coil and a first centerline and a first rotor installed on an eccentric shaft such that the first rotor rolls in to and out of contact with portions of the first stator. In an example embodiment, the electric propulsion device has a housing and a bearing. The stator is installed in the housing and the bearing positions the eccentric shaft about the first centerline. In an example embodiment, the at least one first wire coil is a plurality of wire coils that are energized fully or partially to rotate the first rotor in the first stator.

In some example embodiments, the first stator is radially outside of the first rotor. In an example embodiment, the first stator includes at least one radially inwardly extending protrusion, and the at least one first wire coil is wound around the at least one protrusion. In some example embodiments, the first stator is radially inside of the first rotor. In an example embodiment, the first stator includes at least one radially outwardly extending protrusion, and the at least one first wire coil is wound around the at least one protrusion.

In some example embodiments, the electric propulsion device includes a second stator and a second rotor. The second stator encircles the first centerline and includes a second wire coil. The second rotor is installed on the eccentric shaft at a phase angle such that the second rotor contacts the second stator when the first rotor is out of contact with the first stator. In an example embodiment, the at least one first wire coil connects a first alternating current phase to ground and the second wire coil connects a second alternating current phase, offset from the first phase, to ground. The second stator includes a third wire coil, circumferentially offset from the second wire coil, that connects the first alternating current phase to ground in parallel with the at least one first wire coil. The first stator includes a fourth wire coil, circumferentially offset from the at least one first wire coil, that connects the second alternating current phase to ground in parallel with the second wire coil.

Other example aspects broadly comprise an electric propulsion device including a stator, a shaft and a rotor. The shaft includes an external gear. The rotor includes an internal gear drivingly engaged with the external gear such that the rotor wobbles in and out of contact with particular portions of the stator as it rotates about the external gear. In an example embodiment, a rotational speed of the shaft is approximately forty times greater than or less than a rotational speed of the rotor. In an example embodiment, a varying contact region between the rotor and stator yields a near zero air gap.

In some example embodiments, the stator includes a plurality of arcuate segments aligned with a plurality of coils. In an example embodiment, the contact between the rotor and the stator occurs at the arcuate segments. In some example embodiments, a charge of the coils varies between positive and negative to rotate the rotor about the stator. In an example embodiment, the charge is positive where the rotor contacts the stator. In an example embodiment, the electric propulsion device includes a second rotor and a second stator for canceling an imbalance from the other rotor and stator.

### BRIEF DESCRIPTION OF THE DRAWINGS

The nature and mode of operation of the present invention will now be more fully described in the following detailed description taken with the accompanying drawing figures, in which:

FIG. 1 is a front view of an electric propulsion device according to an example aspect;

FIG. 2 is a cross-section view of the electric propulsion device of FIG. 1;

FIG. 3 is a front view of an electric propulsion device according to an example aspect;

FIG. 4 is a front view of an electric propulsion device according to an example aspect;

FIG. 5 is a front view of an electric propulsion device according to an example aspect;

FIG. 6 is a cross-section view of an electric propulsion device according to an example aspect.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

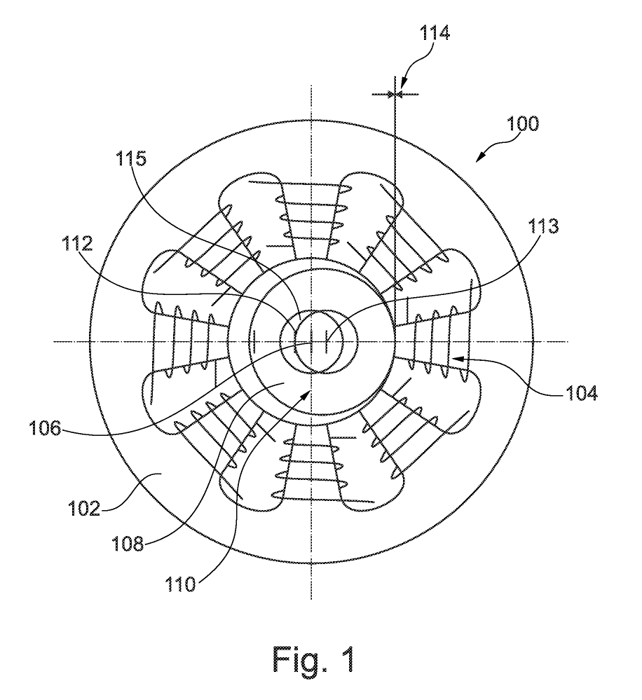

The following description is made with reference to FIG. 1. FIG. 1 is a front view of electric propulsion device 100 according to an example aspect. Electric propulsion device 100 includes stator 102 with wire coil 104 and first centerline 106. Device 100 further includes rotor 108 with optional magnet 110 and eccentric shaft 112. Eccentric shaft 112 includes a main portion with second centerline 113 and lobed portion 115 that shares centerline 106 with the rotor. Rotor 108 is installed on shaft 112, and specifically lobed portion 115, such that rotor 108 rolls in to and out of contact with portions of stator 102 as evidenced by zero clearance dimension 114. Stator 102 and rotor 108 may comprise laminations of iron material.

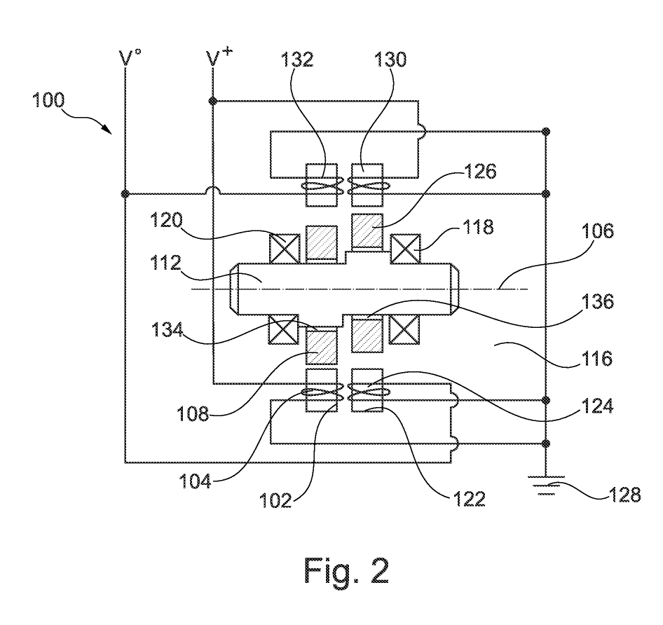

The following description is made with reference to FIGS. 1-2. FIG. 2 is a cross-section view of electric propulsion device 100. Device 100 includes housing 116 and bearings 118 and 120. Stator 102 is installed in housing 116. Bearings 118 and 120 position shaft 112 about centerline 106. Coils 104 are energized fully or partially to rotate the first rotor in the first stator. That is, as the rotor moves into and out of contact with portions of the stator, the portion in contact is fully energized and portions not in contact are partially energized or non-energized. For example, depending on speed and torque, a single coil or up to 180° of coils may be fully or partially energized. The number of coils can vary based on the design requirements.

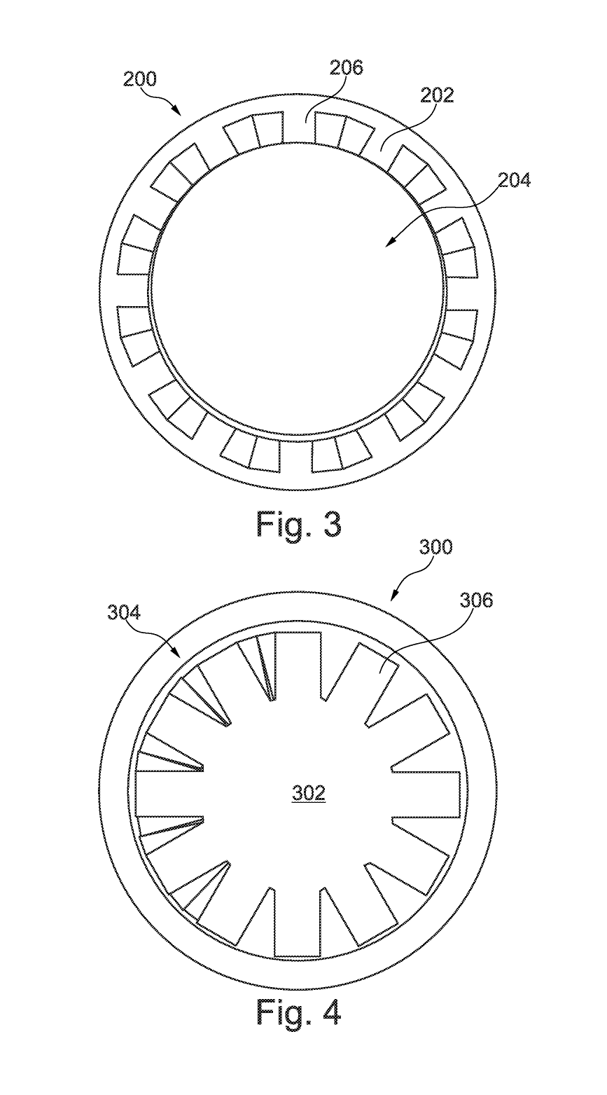

The following description is made with reference to FIG. 3. FIG. 3 is a front view of electric propulsion device 200 according to an example aspect. Device 200 includes stator 202 radially outside of rotor 204. Stator 202 includes radially inwardly extending protrusion 206. Wire coil (not shown) is wound around protrusion 206.

The following description is made with reference to FIG. 4. FIG. 4 is a front view of electric propulsion device 300 according to an example aspect. Device 300 includes stator 302 radially inside of rotor 304. Stator 302 includes radially inwardly extending protrusion 306. Wire coil (not shown) is wound around protrusion 306.

Returning to FIG. 2, device 100 includes stator 122 encircling centerline 106. Stator 122 includes wire coil 124. Rotor 126 is installed on eccentric shaft 112 at a phase angle such that rotor 126 contacts stator 122 when rotor 108 is out of contact with stator 102. Wire coil 104 connects alternating current phase V+ to ground 128. Wire coil 124 connects alternating current phase V0, offset from phase V+, to ground 128. Stator 122 includes wire coil 130, circumferentially offset from wire coil 124, that connects alternating current phase V+ to ground 128 in parallel with wire coil 104. Stator 102 includes wire coil 132, circumferentially offset from wire coil 104, that connects alternating current phase V0 to ground 128 in parallel with wire coil 124. Rotors 108 and 126 are mounted on shaft 112 via bearings or bushings 134 and 136, respectively.

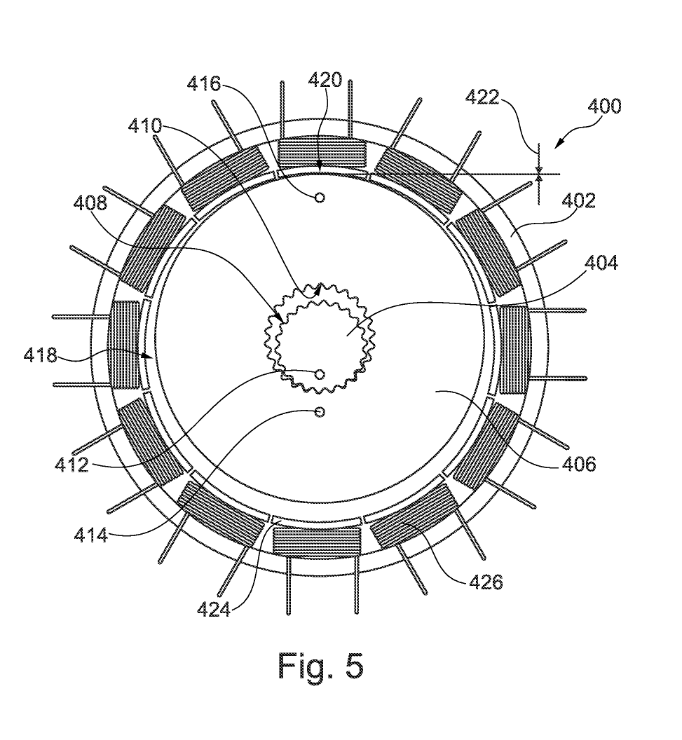

The following description is made with reference to FIG. 5. FIG. 5 is a front view of electric propulsion device 400 according to an example aspect. Device 400 includes stator 402, shaft 404, and rotor 406. Shaft 404 includes external gear 408. Rotor 406 includes internal gear 410 engaged with external gear 408. Gears 408 and 410 have a same pitch diameter but different numbers of teeth. Rotor 406 wobbles in and out of contact with particular portions of the stator as it rotates about the external gear. That is, the rotor moves about shaft gear 408 as the shaft rotates and indicator dot 412 on shaft 404 rotates at a slower speed than indicator dots 414 and 416 on rotor 406. In an example embodiment, a rotational speed of the shaft is approximately forty times greater than or less than a rotational speed of the rotor.

Contact region 418 between rotor 406 and stator 402 varies as the rotor rotates. One contact region (i.e., region 420 in FIG. 5) yields a near zero air gap as indicated by closed dimension 420. The air gap rotates around the motor as the coils are progressively energized. Stator 402 includes arcuate segments 424 aligned with coils 426. Contact, or contact regions 418, between the rotor and the stator occurs at the arcuate segments. During operation of electric propulsion device 400, a charge of coils 426 varies between positive and negative to rotate the rotor about the stator. In an example embodiment, the charge is positive where the rotor contacts the stator. The dual configuration of device 100 of FIG. 2 also applies to device 400 of FIG. 5 so that device 400 may include a second rotor (not shown) and a second stator (not shown) for canceling an imbalance from rotor 406 and stator 402.

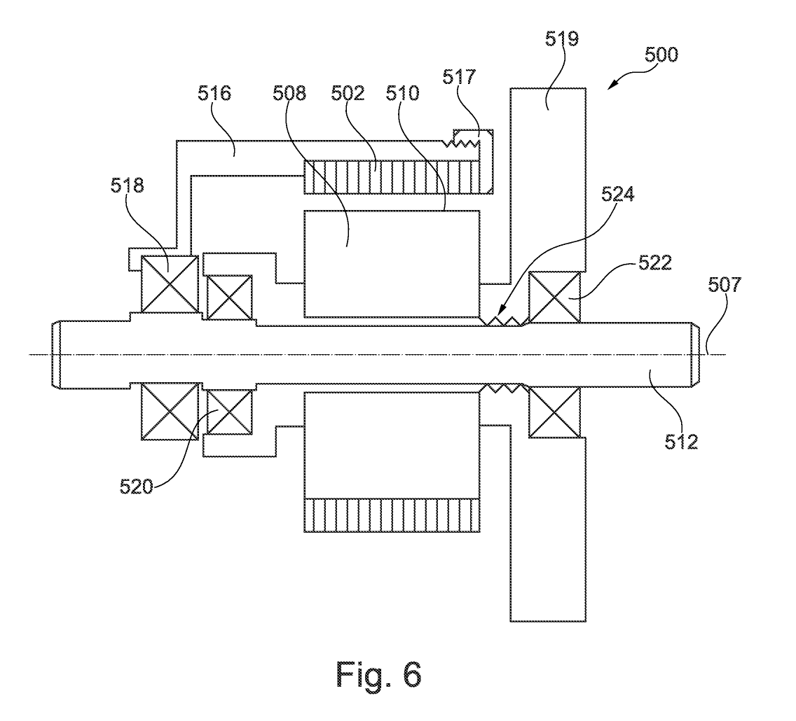

The following description is made with reference to FIG. 6. FIG. 6 is a cross-section view of electric propulsion device 500 according to an example aspect. Electric propulsion device 500 includes stator 502. Device 500 further includes rotor 508 with magnet 510 and eccentric shaft 512. Rotor 508 is installed on shaft 512 such that rotor 508 rolls in to and out of contact with portions of stator 502. Device 500 includes housing 516 and bearing 518. Stator 502 is fixed in housing 516 via threaded cap 517. Rotor 408 is mounted on shaft 512 via rotor housing 519 and bearings 520 and 522. Housing 519 may be a two part housing joined at threaded connection 524, Stator 502 is installed in housing 516. Bearings 520 and 522 position rotor 502 on shaft 512 about shaft centerline 507, distinct from a stator centerline (not shown).

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. An electric propulsion device comprising:
a first stator including at least one first wire coil and a first centerline; and,
a first rotor installed on an eccentric shaft such that the first rotor rolls in to and out of contact with portions of the first stator.

2. The electric propulsion device of claim 1 further comprising:
a housing; and,
a bearing, wherein the stator is installed in the housing and the bearing positions the eccentric shaft about the first centerline.

3. The electric propulsion device of claim 1 wherein the at least one first wire coil is a plurality of wire coils that are energized fully or partially to rotate the first rotor in the first stator.

4. The electric propulsion device of claim 1 wherein the first stator is radially outside of the first rotor.

5. The electric propulsion device of claim 4 wherein the first stator includes at least one radially inwardly extending protrusion, and the at least one first wire coil is wound around the at least one protrusion.

6. The electric propulsion device of claim 1 wherein the first stator is radially inside of the first rotor.

7. The electric propulsion device of claim 6 wherein the first stator includes at least one radially outwardly extending protrusion, and the at least one first wire coil is wound around the at least one protrusion.

8. The electric propulsion device of claim 1 further comprising:
a second stator encircling the first centerline and including a second wire coil; and,
a second rotor installed on the eccentric shaft at a phase angle such that the second rotor contacts the second stator when the first rotor is out of contact with the first stator.

9. The electric propulsion device of claim 8 wherein:
the at least one first wire coil connects a first alternating current phase to ground;
the second wire coil connects a second alternating current phase, offset from the first phase, to ground;
the second stator includes a third wire coil, circumferentially offset from the second wire coil, that connects the first alternating current phase to ground in parallel with the at least one first wire coil; and,
the first stator includes a fourth wire coil, circumferentially offset from the at least one first wire coil, that connects the second alternating current phase to ground in parallel with the second wire coil.

10. An electric propulsion device comprising:
a stator;
a shaft including an external gear; and,
a rotor including an internal gear drivingly engaged with the external gear such that the rotor wobbles in and out of contact with particular portions of the stator as it rotates about the external gear.

11. The electric propulsion device of claim 10 wherein a rotational speed of the shaft is approximately forty times greater than or less than a rotational speed of the rotor.

12. The electric propulsion device of claim 10 wherein a varying contact region between the rotor and stator yields a near zero air gap.

13. The electric propulsion device of claim 10 wherein the stator includes a plurality of arcuate segments aligned with a plurality of coils.

14. The electric propulsion device of claim 13 wherein the contact between the rotor and the stator occurs at the arcuate segments.

15. The electric propulsion device of claim 13 wherein a charge of the coils varies between positive and negative to rotate the rotor about the stator.

16. The electric propulsion device of claim 15 wherein the charge is positive where the rotor contacts the stator.

17. The electric propulsion device of claim 10 further comprising a second rotor and a second stator for canceling an imbalance from the other rotor and stator.
